(19) United States
(12) Patent Application Publication
(10) Pub. No.: US 2007/0030168 A1
(43) Pub. Date: Feb. 8, 2007

(54) Sensor network communication system interworking with broadband wireless access communication system and communication method therefor

(75) Inventors: Young-Ho Kim, Suwon-si (KR); Young-Soo Park, Yongin-si (KR); Jun-Young Jung, Yongin-si (KR); Joon-Young Choi, Suwon-si (KR); Geun-Ho Lee, Suwon-si (KR); Jae-Gwa Lee, Seoul (KR); Dong-Seek Park, Yongin-si (KR); Jae-Yoel Kim, Suwon-si (KR); Chi-Woo Lim, Suwon-si (KR)

Correspondence Address: DILWORTH & BARRESE, LLP, 333 EARLE OVINGTON BLVD., UNIONDALE, NY, 11553, US

(73) Assignee: Samsung Electronics Co., Ltd.

(21) Appl. No.: 11/498,661

(22) Filed: Aug. 3, 2006

(30) Foreign Application Priority Data
Aug. 4, 2005 (KR) 2005-0071246

(51) Int. Cl. H04Q 9/00

(52) U.S. Cl. 340/870.07

(57) ABSTRACT

A sensor network communication system interworking with a BWA communication system and a communication method therefor are provided. In a method for measuring a predetermined target in the sensor network communication system interworking with the BWA communication system, a mobile station or a server sends a measurement request for the predetermined target to a local controller over the BWA communication system. The local controller sends the measurement request to a predetermined sensor and actuator over a wireless communication protocol. The sensor and actuator measures the predetermined target and sends the measurement value to the local controller. The local controller sends a measurement result message based on the measurement value to the mobile station or the server.

### PRIORITY

This application claims priority under 35 U.S.C. §119 to an application entitled “Sensor Network Communication System Interworking with Broadband Wireless Access Communication System and Communication Method Therefor” filed in the Korean Intellectual Property Office on Aug. 4, 2005 and assigned Serial No. 2005-71246, the contents of which are herein incorporated by reference.

### BACKGROUND OF THE INVENTION

1. Field of the Invention

The present invention relates to a system and method for forming a network by installing sensors/actuators configured to have computing capability and communication capability through the integration of sensor network technology and Broadband Wireless Access (BWA) communication technology at predetermined locations, and transferring information collected at the sensors/actuators to a remote place over the network, simultaneously with invoking the sensors/actuators for a certain actuation.

2. Description of the Related Art

Conventionally, a sensor network provides wired connectivity between sensors/actuators and between the sensors/actuators and local controllers. FIG. 1 illustrates the configuration of the conventional sensor network.

Referring to FIG. 1, the conventional sensor network includes, in a predetermined area, a local controller 100 for providing control for the area and sensors/actuators 110 to 122. The local controller 100 is configured to send information received from the sensors/actuators 110 to 122 to a central controller/monitor 104 over a Public Telephone Switched Network (PTSN) 102. The central controller/monitor 104 is a main server for processing the information received from the local controller 100.

The local controller 100 actuates the sensors/actuators 100 to 122, upon receipt of a control request from the central controller/monitor 104 via the PTSN 102.

A drawback with the above conventional sensor network is that because communications are conducted between the sensors/actuators 110 to 122 and the local controller 100 by a particular protocol and wired connectivity, an additional wired link must be installed for deployment of a new sensor/actuator.

FIG. 2 illustrates the configuration of an improved sensor network using a Distributed Monitoring and Control System (DMCS), compared to the sensor network illustrated in FIG. 1.

Referring to FIG. 2, sensors/actuators 210, 212 and 214 send signals to a local gateway 230 via transceivers/repeaters 220 and 222, and the local gateway 230 transfers the signals to a server 240 and at least one of a workstation 242 and a laptop 246 over an Internet 200. The transceivers/repeaters 220 and 222 function to relay signals between the local gateway 230 and the sensors/actuators 210, 212 and 214.

An actuation request from the server 240, the workstation 242, and the laptop 246 may be transferred to the sensors/actuators 210, 212 and 214 in the reverse path.

The server 240, the workstation 242, and the laptop 246 are used for managing the sensors/actuators 214 under the local gateway 230 from a remote place. The server 240 may store information in a database 248.

As with the sensor network illustrated in FIG. 1, the improved sensor network also has the shortcoming that due to the wired connectivity between the local gateway 230 and the server 240, a wired link must be established for installation of a new device.

### SUMMARY OF THE INVENTION

An object of the present invention is to substantially solve at least the above problems and/or disadvantages and to provide at least the advantages below. Accordingly, an object of the present invention is to provide a system and method for forming a network by installing sensors/actuators at predetermined locations, configured to have computing capability and communication capability through the introduction of BWA communication technology to a sensor network, and transferring information collected at the sensors/actuators to a remote place over the network, simultaneously with invoking the sensors/actuators for a predetermined actuation.

The above object is achieved by providing a sensor network communication system interworking with a BWA communication system and a communication method therefor.

According to one aspect of the present invention, in a sensor network communication system interworking with a BWA communication system, a local controller communicates with the BWA communication system, and sends a measurement request or an actuation request received from an MS or a server in the BWA communication system to a sensor and actuator over a wireless communication protocol. The sensor and actuator performs a measurement or an actuation on a predetermined target according to the measurement request or the actuation request received from the local controller.

According to another aspect of the present invention, in a method for measuring a predetermined target in the sensor network communication system interworking with the BWA communication system, an MS or a server sends a measurement request for the predetermined target to a local controller over the BWA communication system. The local controller sends the measurement request to a predetermined sensor and actuator over a wireless communication protocol. The sensor and actuator measures the predetermined target and sends the measurement value to the local controller. The local controller sends a measurement result message based on the measurement value to the MS or the server.

According to a further aspect of the present invention, in a method of performing a predetermined actuation in a sensor network communication system interworking with a BWA communication system, an MS or a server sends an actuation request for the predetermined actuation to a local controller over the BWA communication system. The local controller sends the actuation request to a predetermined sensor and actuator over a wireless communication protocol. The sensor and actuator performs the predetermined actuation and sends an actuation result to the local controller. The local controller sends the actuation result to the MS or the server.

According to still another aspect of the present invention, in a method of reporting a measurement result about a predetermined target in a sensor network communication system interworking with a BWA communication system, a sensor and actuator compares a measurement of the predetermined target with a normal range. If the measurement is outside the normal range, the sensor and actuator sends the measurement to a local controller. The local controller sends a measurement result message based on the measurement to at least one of a mobile station, a server, and a predetermined facility over the BWA communication system.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates the configuration of a conventional sensor network;

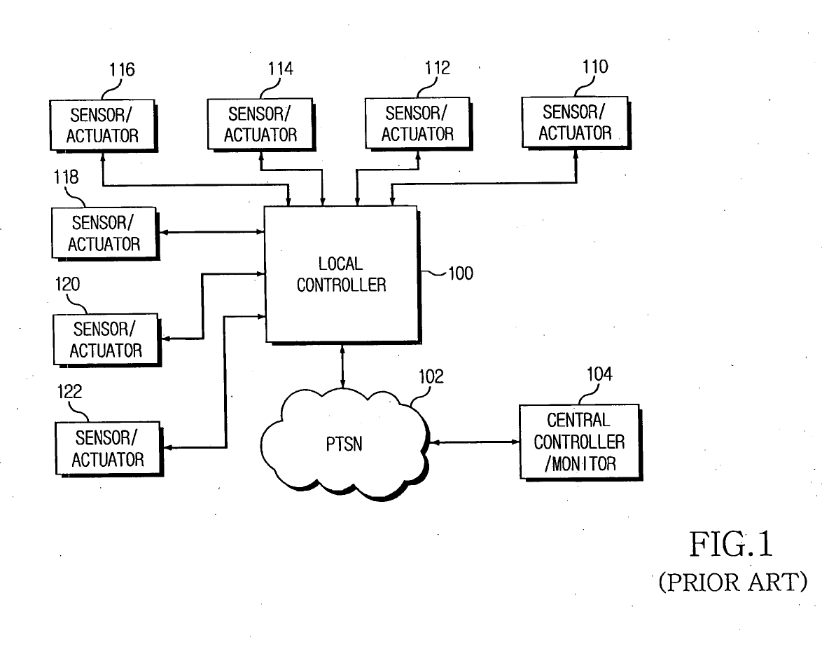

FIG. 2 illustrates the configuration of a conventional sensor network using a DMCS;

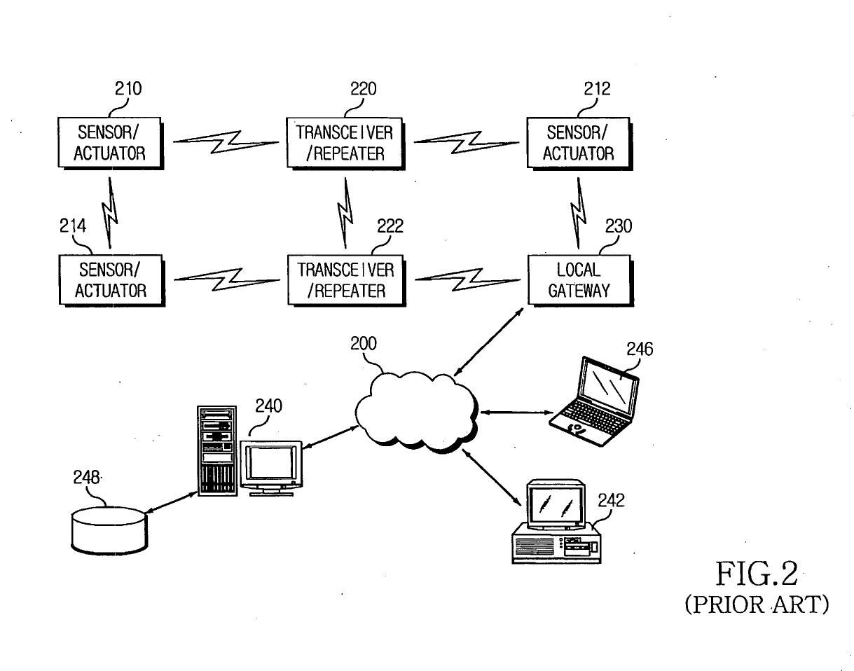

FIG. 3 illustrates the configuration of an Institute of Electrical and Electronics Engineers (IEEE) 802.16 system according to the present invention;

FIG. 4 illustrates the configuration of a sensor network using the IEEE 802.16 system according to the present invention;

FIG. 5 is a block diagram of a local controller according to the present invention;

FIG. 6 is a block diagram of a sensor/actuator according to the present invention;

FIG. 7 is a flowchart illustrating an operation of the local controller according to the present invention;

FIG. 8 is a flowchart illustrating an operation of the sensor/actuator according to the present invention;

FIG. 9 is a diagram illustrating a signal flow for a measurement/actuation procedure when a server or a Mobile Station (MS) generates a measurement or actuation request according to the present invention; and

FIG. 10 is a diagram illustrating a signal flow for an operation for reporting an abnormal measurement in the sensor/actuator according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention is intended to provide a system and method for communications over a wireless communication protocol in a sensor network.

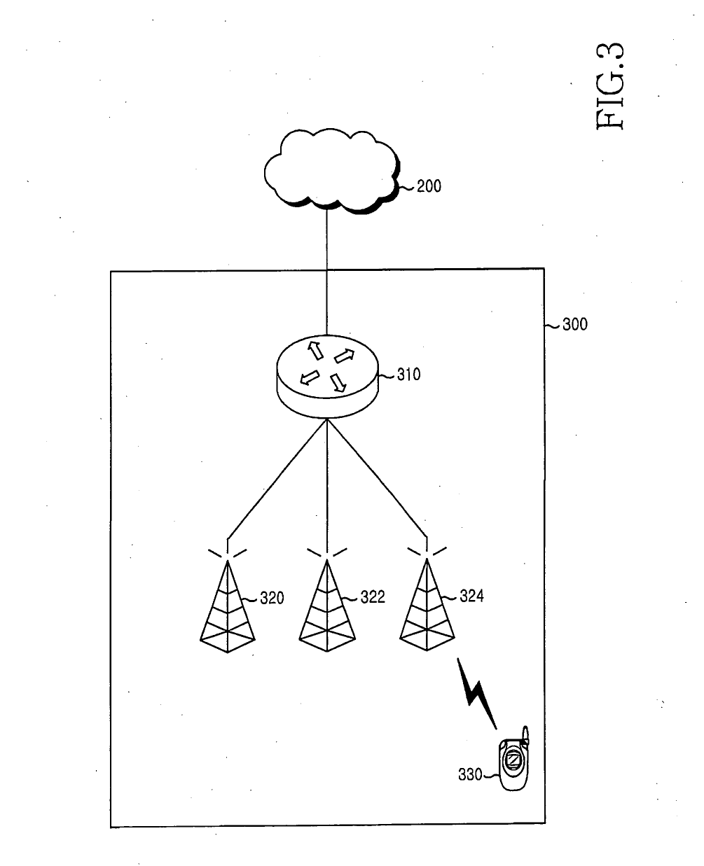

FIG. 3 illustrates the configuration of a BWA communication system according to the present invention. While the present invention is described in the context of an IEEE 802.16 system as the BWA communication system, it is obviously understood that the present invention is applicable to any other BWA communication system. IEEE 802.16 is a kind of wireless communication protocol that enables high-speed data communication at up to 6 Mbps even when an MS moves at high speed, for example, at 60 km/h.

Referring to FIG. 3, the IEEE 802.16 system includes an Access Network (AN) 300 and an MS 330 wirelessly connected to the AN 300.

The AN 300 provides wireless connectivity in compliance with the IEEE 802.16 standards. The AN 300 is comprised of Radio Access Stations (RASs) 320, 322 and 324 for providing wireless communication services to the MS 330, and an Access Control Router (ACR) 310 for interfacing the RASs 320, 322 and 324 with an Internet Protocol (IP) network, serving as a router for the Internet 200, and exchanging information between the Internet 200 and the MS 330.

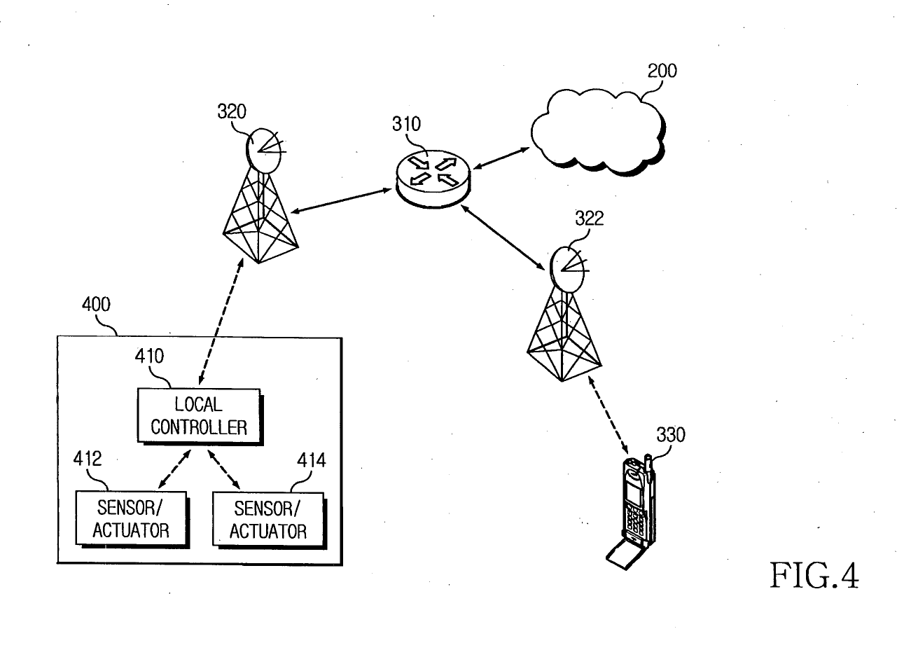

FIG. 4 illustrates the configuration of a sensor network using the IEEE 802.16 system according to the present invention.

Referring to FIG. 4, the sensor network includes a local controller 410 for attaching to the IEEE 802.16 system at a predetermined location 400 and sending a measurement request or an actuation request received from an entity of the IEEE 802.16 system, and sensors/actuators 412 and 414 for measuring or operating upon receipt of the measurement or actuation request from the local controller 410.

In operation, when an MS 330 requests a measurement on the predetermined location 400 to the sensors/actuators 412 and 414, the measurement request is sent to the local controller 410 over the IEEE 802.16 system.

The local controller 410 forwards the measurement request to the sensors/actuators 412 and 414. After measuring, the sensors/actuators 412 and 414 send the measurements to the local controller 410 which in turn forwards the measurements to the MS 330 over the IEEE 802.16 system.

When the MS 330 requests an actuation of the sensors/actuators 412 and 414 for the predetermined location 400, the actuation request is sent to the local controller 410 over the IEEE 802.16 system.

The local controller 410 forwards the actuation request to the sensors/actuators 412 and 414. After being actuated, the sensors/actuators 412 and 414 send the actuation result to the local controller 410 which in turn forwards the actuation result to the MS 330 over the IEEE 802.16 system.

In accordance with the present invention, a server (not shown) responsible for managing the local controller 410 and the sensors/actuators 412 and 414 may issue a measurement request and an actuation request to the sensors/actuators 412 and 414.

Even when the server or the MS 330 generates no measurement requests, the sensors/actuators 412 and 414 perform a periodic measurement. If the measurement lies outside a normal range, the sensors/actuators 412 and 414 may report the abnormal measurement to the MS 330, the server or a corresponding facility (e.g. a fire station).

The local controller 410 and the MS 330 access the Internet 200 in compliance with IEEE 802.16.

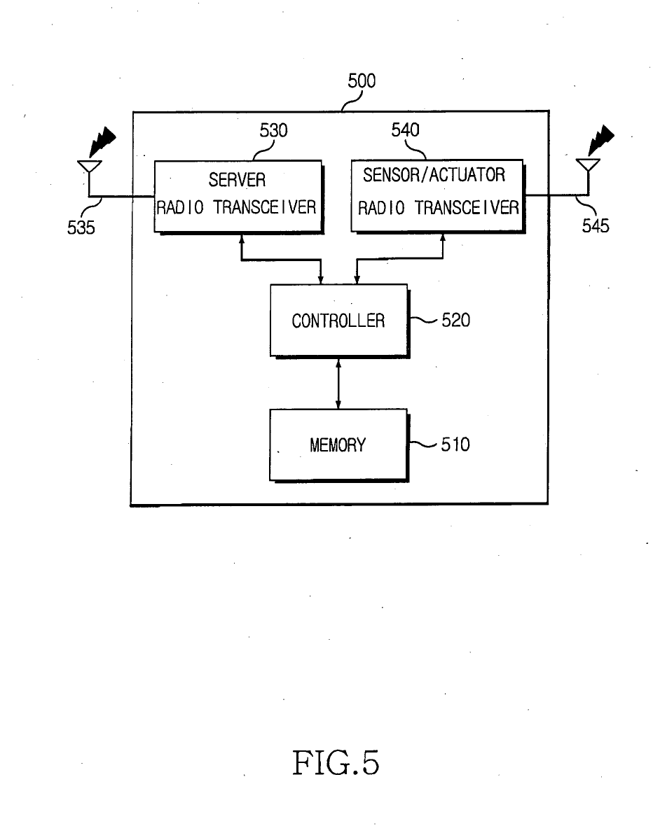

FIG. 5 is a block diagram of the local controller 410 according to the present invention. The local controller is labeled with reference numeral 500 in FIG. 5.

Referring to FIG. 5, in the local controller 500, a server radio transceiver 530 exchanges signals and data with the RASs 320 and 322 and the ACR 310 through an antenna 535. The signals and data are processed in compliance with IEEE 802.16.

A sensor/actuator radio transceiver 540 exchanges signals and data with the sensors/actuators 412 and 414 through an antenna 545. The signals and data are processed in compliance with the Bluetooth standards or Wireless Local Area Network (WLAN) standards, i.e. IEEE 802.11a/b/g.

A controller 520 provides overall control to the local controller 500. For example, the controller 520 controls signal and data transmission/reception of the server radio transceiver 530 and the sensor/actuator radio transceiver 540. The typical functionalities of the controller 520 will not be described herein.

A memory 510 stores the micro-codes of programs used for processing and control of the controller 520 and reference data. It serves as a working memory for the controller 520, which temporarily stores data generated during execution of programs. It also stores updatable data to be kept, such as setting values of the controller 520.

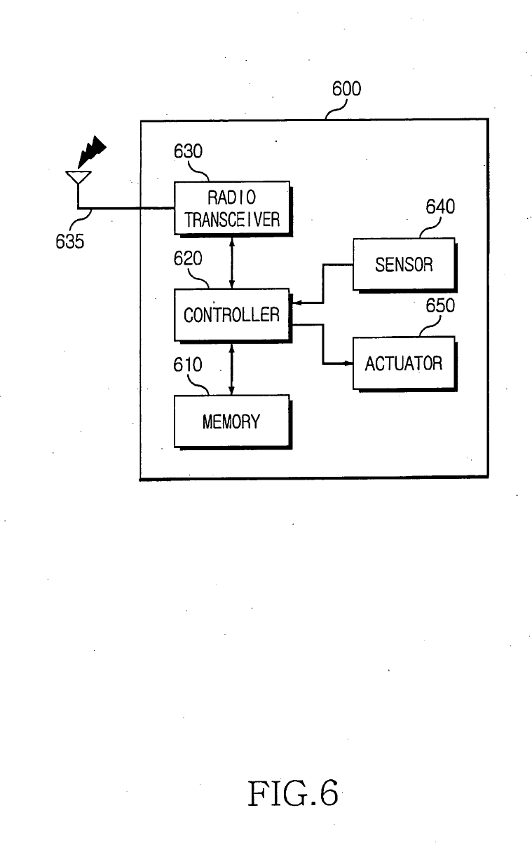

FIG. 6 is a block diagram of the sensor/actuator 412 or 414 according to an embodiment of the present invention. The sensor/actuator is denoted by reference numeral 600 in FIG. 6.

Referring to FIG. 6, in the sensor/actuator 600, a radio transceiver 630 sends/receives signals and data through an antenna 635. The signals and data are processed in compliance with the standards for Bluetooth or the standards for WLAN, i.e. IEEE 802.11a/b/g.

A controller 620 provides overall control to the sensor/actuator 600. For example, the controller 620 controls the signal and data transmission/reception of the radio transceiver 630. A detailed description of the typical functionalities of the controller 620 is not provided herein.

A memory 610 stores the micro-codes of programs used for processing and control of the controller 620 and reference data. It serves as a working memory for the controller 620, which temporarily stores data generated during execution of programs. It also stores updated data to be kept, such as setting values of the controller 620.

A sensor 640 is a device for measuring smoke, temperature, motion, and gas. Depending on the location of the sensor/actuator 600, the sensor 640 may be equipped with at least one of the smoke, temperature, motion, and gas measuring functions. The sensor 640 sends the resulting measurement to the controller 620.

An actuator 650 is actuated upon request of the controller 620. Actuations of the actuator 650 are those of an electric motor, including opening/closing a gas valve and switch-on/off of a predetermined device.

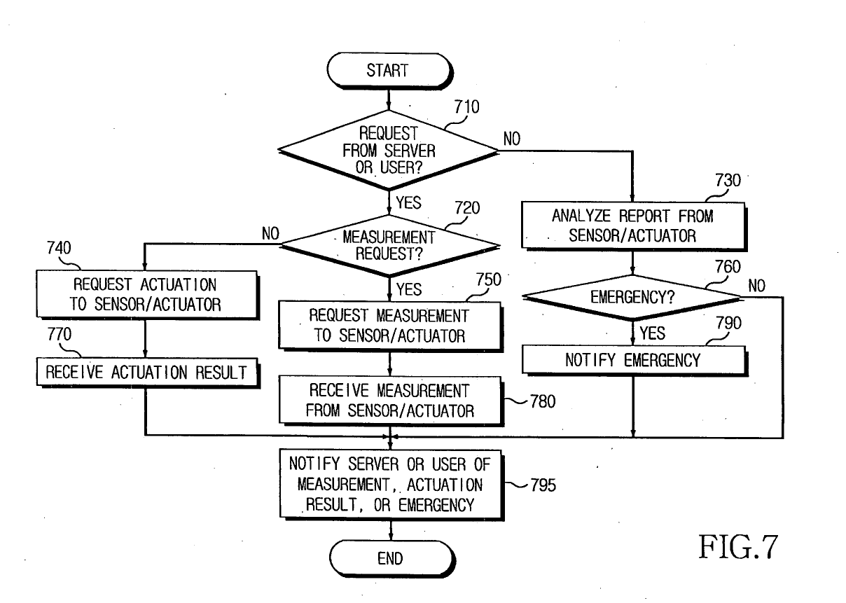

FIG. 7 is a flowchart illustrating an operation of the local controller 500 according to the present invention.

Referring to FIG. 7, the controller 520 of the local controller 500 determines whether received information indicates a measurement/actuation request to a particular sensor/actuator from a server or a user in step 710.

If the received information is not a request from the user or the server, which implies that the received information is an abnormal measurement report from the sensor/actuator 600, the controller 520 analyzes the abnormal measurement report in step 730.

If the abnormal measurement report is associated with an emergency (e.g. gas leakage or fire alarm), the controller 520 notifies a corresponding facility (e.g. a fire station or gas company) of the emergency in step 790 and also notifies the server or the user of the emergency in step 795.

On the other hand, if the received information is a request from the server or the user in step 710, the controller 520 determines whether the request is a measurement request or an actuation request in step 720.

In the case of the measurement request, the controller 520 requests a measurement to the sensor/actuator 600 in step 750 and receives the measurement from the sensor/actuator 600 in step 780.

In step 795, the controller 520 sends the measurement to the server or the user.

In the case of the actuation request in step 720, the controller 520 sends the actuation request to the sensor/actuator 600 in step 740 and receives an actuation result from the sensor/actuator 600, such as actuation success in step 770.

The controller 520 notifies the server or the user of the actuation result in step 795. Then the controller 520 terminates the algorithm of the present invention.

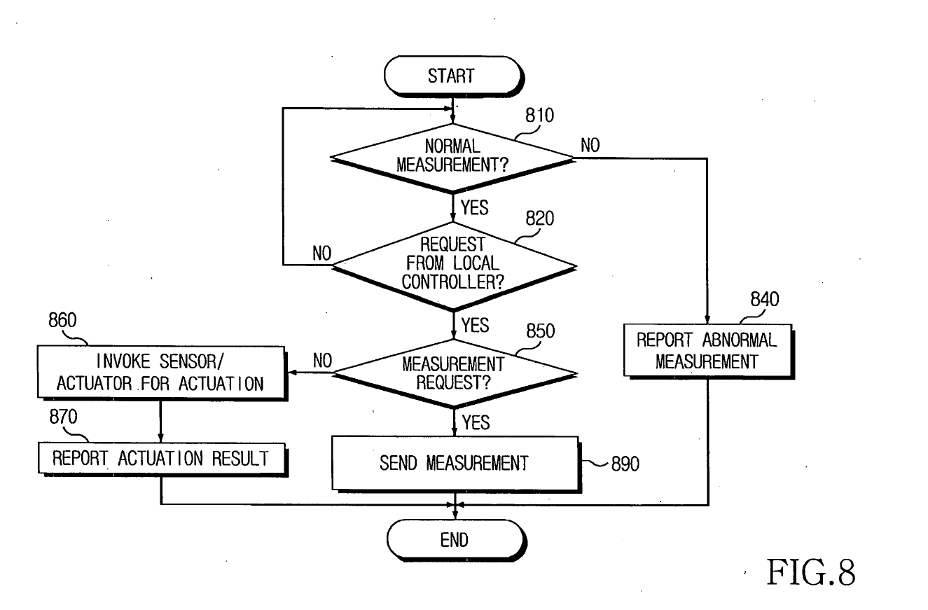

FIG. 8 is a flowchart illustrating an operation of the sensor/actuator 600 according to the present invention.

Referring to FIG. 8, the controller 620 of the sensor/actuator 600 checks whether a measurement at the sensor 640 lies within a normal range in step 810.

If the measurement is outside the normal range, the controller 620 sends an abnormal measurement report to the local controller 500 in step 840.

If the measurement falls within the normal range, the controller 620 determines whether a request has been received from the local controller 500 in step 820.

Upon receipt of the request, the controller 620 determines whether the request is about measuring in step 850.

In the case of a measurement request, the controller 620 sends the measurement acquired in step 810 to the local controller 500 in step 890.

In the case of an actuation request, the controller 620 invokes the actuator 650 for a predetermined actuation in step 860 and sends the actuation result to the local controller 500 in step 870. Then the controller 620 ends the algorithm of the present invention.

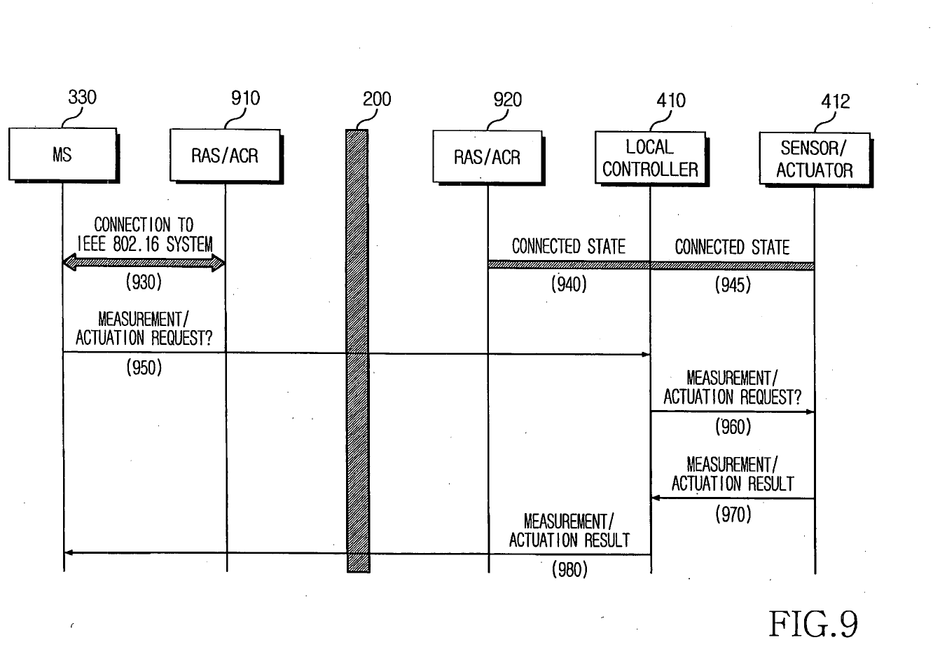

FIG. 9 is a diagram illustrating a signal flow for a measurement/actuation procedure when a server or an MS generates a measurement or actuation request according to the present invention.

Referring to FIG. 9, the MS 330 and a RAS/ACR 910 are located in a network, and a RAS/ACR 920, the local controller 410, and the sensor/actuator 412 are located in another network.

In step 930, the MS 330 is connected to the IEEE 802.16 system in the following procedure.

(1) Ranging: the MS 330 performs ranging during network entry to correct its uplink data transmission timing and adjust its frequency and power.

(2) Subscriber Station (SS) Basic Capabilities (SBC): the MS 330 exchanges physical parameters and authentication policy information with the RAS 910.

(3) Privacy Key Management (PKM): key information necessary for authenticating Medium Access Control (MAC) messages and traffic encryption is exchanged between the MS 330 and the RAS 910. In this PKM phase, authentication of the MS 330 and subscriber authentication are carried out.

(4) Registration (REG): registration information including Service Flow (SF) and IP Convergence Sublayer (CS) capability information, mobility information, and Automatic Repeat reQuest (ARQ) parameters is exchanged between the MS 330 and the ACR 910.

(5) Dynamic Service Addition (DSA): to establish a new connection between the MS 330 and the RAS 910, a Connection ID (CID) is allocated and the SF and IP CS information of the connection is exchanged between them. Then the MS 330 is connected to the IEEE 802.16 communication system.

To enable the RAS/ACR 910 and the local controller 410 to be able to communicate with each other at any time, they are kept in a connected state in step 940. Likewise, the local controller 410 and the sensor/actuator 412 are kept in a connected state to enable communications between them at any time in step 945.

The MS 330 sends a measurement request message to the local controller 410 in step 950, and the local controller 410 forwards the measurement request message to the sensor/actuator 412 in step 960.

The sensor/actuator 412 responds to the local controller 410 with a measurement result message containing a measurement in step 970 and the local controller 410 forwards the measurement result message to the MS 330 in step 980.

If the MS 950 sends an actuation request message to the local controller 410 in step 950, and the local controller 410 forwards the actuation request message to the sensor/actuator 412 in step 960.

The sensor/actuator 412 performs the requested actuation and responds to the local controller 410 with an actuation result message containing an actuation result in step 970 and the local controller 410 forwards the actuation result message to the MS 330 in step 980.

While not shown, when a predetermined server sends a measurement/actuation request instead of the MS 330, the same procedure is performed.

If Internet Protocol version 6 (IPv6) is used, there are sufficient IPv6 addresses. Thus, IPv6 addresses can be allocated to the local controller 410 and the sensor/actuator 412.

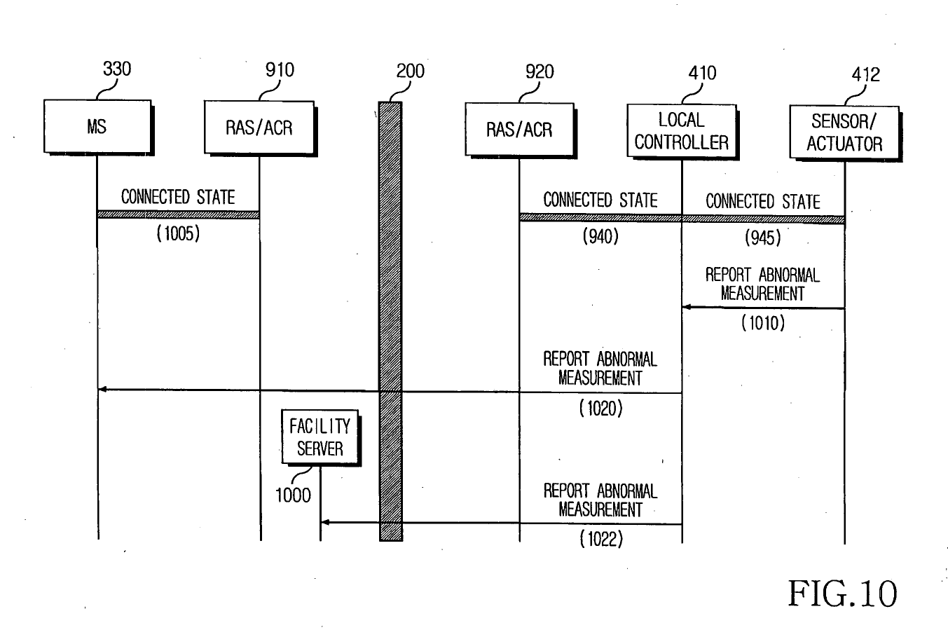

FIG. 10 is a diagram illustrating a signal flow for an operation for reporting an abnormal measurement in the sensor/actuator according to the present invention.

Referring to FIG. 10, the MS 330 and the RAS/ACR 910 are located in a network, and the RAS/ACR 920, the local controller 410, and the sensor/actuator 412 are located in another network. A predetermined facility server 1000 may reside in a third network.

To enable the RAS/ACR 910 and the local controller 410 to be able to communicate with each other at any time, they are kept in a connected state in step 940. Likewise, the local controller 410 and the sensor/actuator 412 are kept in a connected state to enable communications between them at any time in step 945. The following description focuses on a connected state 1005 between the MS 330 and the RAS/ACR 910 after a connection is established between them.

If a measurement acquired during a measuring operation is outside a normal range, the sensor/actuator 412 sends an abnormal measurement report message containing the abnormal measurement to the local controller 410 in step 1010. The local controller 410 forwards the abnormal measurement report message to the MS 330 in step 1020.

At the same time, the local controller 410 sends the abnormal measurement message to the facility server 1000 in step 1022.

In the case where the local controller 410 is installed in a vehicle and the sensor/actuator 412 is provided to a sensor or a switch in the vehicle, the user of the MS 330 is informed of the status of the vehicle. When the sensor senses an abnormal measurement, the abnormal measurement is reported to the server, the MS 330, and the facility server 1000.

As described above, the present invention advantageously adds a new network or device wirelessly to a sensor network by introducing the BWA communication technology into the sensor network. That is, the new network or device can be easily installed wirelessly and the widely used IP is adopted. Therefore, the present invention offers the benefits of easy connection, fast counteraction, and easy management.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A sensor network communication system interworking with a Broadband Wireless Access (BWA) communication system, comprising:
a local controller for communicating with the BWA communication system, and sending a measurement request or an actuation request received from a mobile station or a server in the BWA communication system to a sensor and actuator over a wireless communication protocol; and
the sensor and actuator for performing a measurement or an actuation on a predetermined target according to the measurement request or the actuation request received from the local controller.

2. The sensor network communication system of claim 1, wherein the wireless communication protocol is one of Bluetooth and Wireless Local Area Network (WLAN).

3. A local controller in a sensor network communication system interworking with a Broadband Wireless Access (BWA) communication system, comprising:
a server radio transceiver for communicating with one of a mobile station, a server, and a predetermined facility over the BWA communication system;
a sensor and actuator radio transceiver for communicating with a sensor and actuator; and
a controller for controlling operation of the server radio transceiver and controlling measurement and actuation of the sensor and actuator.

4. The local controller of claim 3, wherein the sensor and actuator radio transceiver operates in compliance with Bluetooth and Wireless Local Area Network (WLAN).

5. A sensor and actuator in a sensor network communication system interworking with a Broadband Wireless Access (BWA) communication system, comprising:
a radio transceiver for communicating with a local controller;
a controller for providing overall control to the radio transceiver and processing a measurement request or an actuation request received from the local controller;
a sensor for measuring a predetermined target; and
an actuator for performing a predetermined actuation.

6. The sensor and actuator of claim 5, wherein the radio transceiver operates in compliance with one of Bluetooth and Wireless Local Area Network (WLAN).

7. The sensor and actuator of claim 5, wherein the sensor senses at least one of gas leakage, fire, and oil leakage.

8. The sensor and actuator of claim 5, wherein the predetermined actuation is an operation which an electric motor can activate.

9. The sensor and actuator of claim 8, wherein the predetermined actuation is at least one of gas valve closing and oil valve closing.

10. A method for measuring a predetermined target in a sensor network communication system interworking with a Broadband Wireless Access (BWA) communication system, comprising the steps of:
sending a measurement request for the predetermined target to a local controller over the BWA communication system by a mobile station or a server;
sending the measurement request to a predetermined sensor and actuator over a wireless communication protocol by the local controller; and
measuring the predetermined target by the sensor and actuator.

11. The method of claim 10, further comprising the steps of:
sending a measurement value to the local controller by the sensor and actuator; and
sending a measurement result message based on the measurement value to the mobile station or the server by the local controller.

12. The method of claim 10, wherein the wireless communication protocol is one of Bluetooth and Wireless Local Area Network (WLAN).

13. The method of claim 10, wherein the predetermined target is at least one of gas leakage, fire, and oil leakage.

14. A method of performing a predetermined actuation in a sensor network communication system interworking with a Broadband Wireless Access (BWA) communication system, comprising the steps of:
sending an actuation request for the predetermined actuation to a local controller over the BWA communication system by a mobile station or a server;
sending the actuation request to a predetermined sensor and actuator over a wireless communication protocol by the local controller; and
performing the predetermined actuation by the sensor and actuator.

15. The method of claim 14, further comprising the steps of:
sending an actuation result to the local controller by the sensor and actuator; and
sending the actuation result to the mobile station or the server by the local controller.

16. The method of claim 14, wherein the wireless communication protocol is one of Bluetooth and Wireless Local Area Network (WLAN).

17. The method of claim 14, wherein the predetermined actuation is an actuation that an electric motor can invoke.

18. The method of claim 17, wherein the predetermined actuation is at least one of gas valve closing and oil value closing.

19. A method of reporting a measurement result about a predetermined target in a sensor network communication system interworking with a Broadband Wireless Access (BWA) communication system, comprising the steps of:
comparing a measurement of the predetermined target with a normal range by a sensor and actuator;
sending the measurement to a local controller by the sensor and actuator, if the measurement is outside the normal range; and
sending a measurement result message based on the measurement to at least one of a mobile station, a server, and a predetermined facility over the BWA communication system by the local controller.

20. A method of sensing the state of a vehicle using a sensor network communication system interworking with a Broadband Wireless Access (BWA) communication system, comprising the steps of:
sending a measurement request for a predetermined target to a local controller installed in the vehicle over the BWA communication system by at least one of a mobile station and a server;
sending the measurement request to a sensor and actuator by the local controller;
sending a measurement of the predetermined target to the local controller by the sensor and actuator; and
sending a measurement result message based on the measurement to the at least one of the mobile station and the server by the local controller.

21. The method of claim 20, wherein the sensor and actuator senses at least one of oil temperature, fuel leakage, a remaining fuel amount.

22. An actuation method in a local controller in a sensor network communication system interworking with a Broadband Wireless Access (BWA) communication system, comprising the steps of:
receiving one of a measurement request and an actuation request from at least one of a mobile station and a server over the BWA communication system;
sending the measurement request or the actuation request to a sensor and actuator over a wireless communication protocol;
receiving a measurement or an actuation result from the sensor and actuator; and
sending a measurement result message based on the measurement or an actuation result message based on the actuation result to the at least one of the mobile station and the server.

23. The actuation method of claim 22, wherein the wireless communication protocol is one of Bluetooth and Wireless Local Area Network (WLAN).
